(19) United States
(12) Patent Application Publication
(10) Pub. No.: US 2008/0135119 A1
(43) Pub. Date: Jun. 12, 2008

(54) PROTECTIVE SLEEVE ASSEMBLY HAVING A SUPPORT MEMBER AND METHOD OF CONSTRUCTION

(76) Inventors: Takashi Tonooka, Shizuoka-Ken (JP); Philip E. Marks, Chester Springs, PA (US)

Correspondence Address: ROBERT L. STEARS;Dickinson Wright PLLC, Suite 2000, 38525 Woodward Avenue, Bloomfield Hills, MI, 48304-2970, US

(21) Appl. No.: 11/951,624

(22) Filed: Dec. 6, 2007

Related U.S. Application Data
(60) Provisional application No. 60/868,961, filed on Dec. 7, 2006.

(51) Int. Cl. F16L 11/00

(52) U.S. Cl. 138/110; 29/282; 138/128; 138/167

(57) ABSTRACT

An elongate sleeve for protecting elongate members and method of construction thereof has a textile sleeve with a wall having an inner surface providing a cavity extending along a longitudinal axis of the sleeve for receiving the elongate members. A resilient support member is arranged in communication with the wall. The support member has an arcuate shape in lateral cross-section with an outer convex surface facing outwardly from the axis for flush engagement with the inner surface of the wall and an inner concave surface facing inwardly toward the axis. The support member extends less than completely about a circumference of the inner surface.

### CROSS-REFERENCE TO RELATED APPLICATION

This application claims the benefit of U.S. Provisional Application Ser. No. 60/868,961, filed Dec. 7, 2006, which is incorporated herein by reference in its entirety.

### BACKGROUND OF THE INVENTION

1. Field of the Invention

This invention relates generally to textile sleeves for receiving and protecting elongated items and methods of construction thereof.

2. Background of the Invention

Protective sleeving is used throughout the industrial, automotive, marine and aerospace industries to organize and protect elongated items, such as wiring harnesses and optical fiber cables, for example. The sleeving surrounds the elongated items and protects them against cuts, abrasion, radiant heat, vibration induced wear and other harsh environmental threats. When positioned within protective sleeving, the wiring or cables are also held together in a neat bundle, allowing a multiplicity of different items to be handled as a sub-assembly, thus saving time and effort during integration of the items into their end environment.

In some applications, while in use, the elongated items being protected need to move along with items to which they are attached, such as in an electronically actuated sliding door application, vehicle trunk lids or hoods, or a printer application, for example. Accordingly, not only do the protective sleeves need to provide protection to the elongated items, but they also need to provide the elongate items with an ability to move freely, desirably without allowing the elongated items to become kinked, sag, entangled or otherwise become damaged. Known protective sleeves that provide protection to elongate members while providing a limited range of movement include corrugated tubing and linked tubing segments, sometimes referred to as caterpillar type tubing. Although these products can prove useful, they generally come at a relatively high cost, largely due to the complex manufacturing processes and materials required for their construction, and can also be bulky, relatively heavy, and overly restrict the freedom of movement of the elongate items.

### SUMMARY OF THE INVENTION

An elongate sleeve for protecting elongate members has a textile sleeve with a wall having an inner surface providing a cavity extending along a longitudinal axis of the sleeve for receiving the elongate members. A resilient support member is arranged in communication with the wall. The support member has an arcuate shape in lateral cross-section with an outer convex surface facing outwardly from the axis for flush engagement with the inner surface of the wall and an inner concave surface facing inwardly toward the axis. The support member extends less than completely about a circumference of the inner surface.

Another aspect of the invention provides a method of constructing an elongate sleeve assembly for protecting elongate members. The method includes forming a sleeve having a wall with an inner surface providing a cavity extending along a longitudinal axis of the sleeve for receiving the elongate members. The method further includes disposing a resilient support member in communication with the wall, wherein the support member can be disposed directly into the cavity, or interlaced within the wall of the sleeve. The support member has an arcuate shape in lateral cross-section with an outer convex surface arranged to face outwardly from the axis and an inner concave surface arranged to face inwardly toward the axis, wherein the support member extends less than completely about a circumference of the sleeve inner surface.

Further aspects of the invention include forming the sleeve having a continuous tubular closed wall, or having an open wall with opposite free edges extending along the length of the sleeve. If formed having an open wall, the sleeve can be heat-set into a curled shape, wrapped and fastened into a curled shape, or biased into a self-curling shape via yarns forming the sleeve. Regardless of whether the sleeve wall is constructed as a tubular closed wall or an open wall, the support member can be interlaced within the wall to provide a unitized sub-assembly.

The support member facilitates maintaining the elongate members within the sleeve in a neat, organized package, while also maintaining the sleeve in a biased position to prevent damage to the elongate members therein. The resilient characteristics of the support member prevent the sleeve from sagging, and also prevent the elongate members from being kinked, entangled or otherwise damaged while the sleeve configuration is changed in use.

### BRIEF DESCRIPTION OF THE DRAWINGS

These and other aspects, features and advantages of the present invention will become more readily appreciated when considered in connection with the following detailed description of the presently preferred embodiments and best mode, appended claims and accompanying drawings, in which:

FIG. 1 is a side view of a protective sleeve assembly according to one presently preferred embodiment;

FIG. 2 is a schematic cross-sectional view of the sleeve assembly taken generally along line 2-2 of FIG. 1;

FIG. 3 is a partial perspective view of the protective sleeve assembly of FIG. 1 shown in a U-shaped position;

FIG. 4 is a schematic plan view of a protective sleeve assembly constructed according to another presently preferred embodiment shown in an unwrapped state;

FIG. 5A is a knit diagram showing a portion of the knit pattern of the sleeve assembly of FIG. 4;

FIG. 5B is a knit diagram showing a remaining portion of the knit pattern of the sleeve assembly of FIG. 4;

FIG. 6 is schematic perspective view showing the protective sleeve assembly of FIG. 4 shown in a partially wrapped state;

FIG. 7 is a schematic perspective view of a protective sleeve assembly constructed according to yet another presently preferred embodiment;

FIG. 8 is a partial perspective view of a sleeve assembly constructed according to yet another presently preferred embodiment;

FIG. 9 is a schematic cross-sectional view taken generally along the line 9-9 of FIG. 8;

FIG. 10 is a schematic cross-sectional view of the sleeve of FIG. 8 showing the sleeve assembly in a partial state of construction;

FIG. 11 is a schematic cross-sectional view similar to FIG. 10 showing the sleeve assembly in a different partial state of construction; and

FIG. 12 is a schematic side view showing a storage container for storing and dispensing protective sleeve assemblies constructed in accordance with the invention.

### DETAILED DESCRIPTION OF PRESENTLY PREFERRED EMBODIMENTS

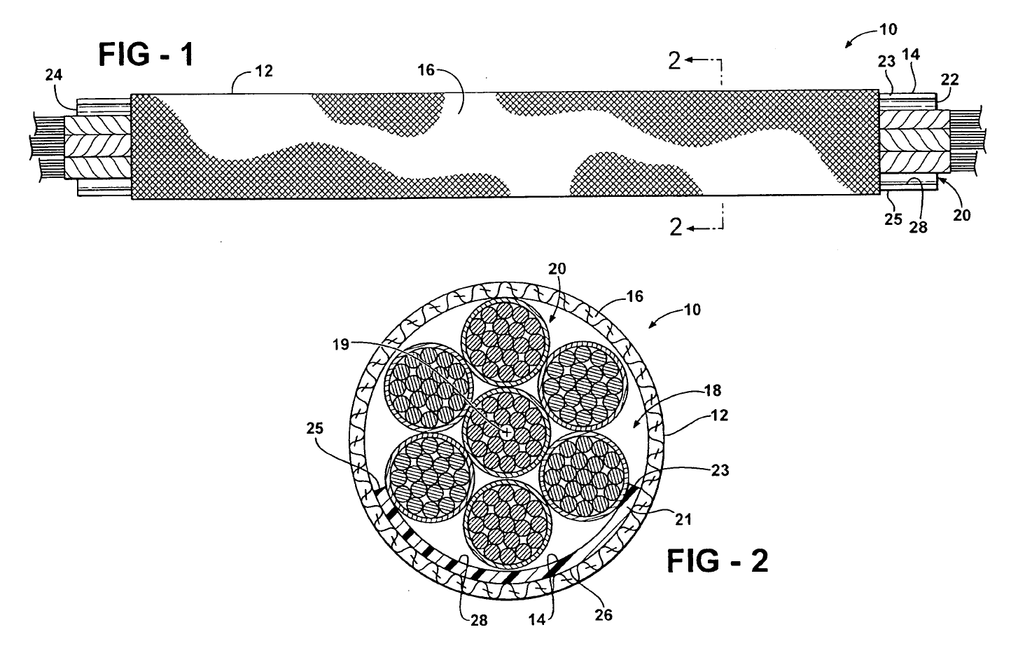

Referring in more detail to the drawings, FIGS. 1-3 show a protective sleeve assembly 10 constructed in accordance with one presently preferred embodiment. The protective sleeve assembly 10 has a sleeve 12 and a batten or resilient support member 14. The sleeve 12 is constructed from a textile fabric, and is represented here, by way of example, as having a closed, circumferentially continuous tubular wall 16. The wall 16 provides at least in part an inner cavity 18 sized for receipt of a elongated members 20, such as separate wires or a wiring harness, for example. The support member 14, while in close communication with the wall 16, also provides in part the cavity 18 and is shown here, for example, as being received generally in the cavity 18 radially outwardly from a longitudinal central axis 19 and in close abutment with the wall 16. The support member 14 provides support to the sleeve 12 and facilitates movement of the sleeve 12 and the elongate members 20 while bending or otherwise manipulating the sleeve 12, particularly while in use. While the sleeve assembly 10 is being bent or otherwise moved and manipulated in use, the support member 14 keeps the elongated members 20 from sagging, becoming kinked, getting entangled or otherwise becoming damaged. Accordingly, the protective sleeve assembly 10 is particularly useful in applications where bending or flexing movement of at least a portion of the protective sleeve assembly 10 and elongate members 20 occurs in use, such as, by way of example and without limitations, in sliding door applications, vehicle trunk lid applications and vehicle hood applications.

The sleeve 12 may be formed by suitable methods of constructing textile fabrics, such as weaving, braiding, knitting and crocheting, which are all considered, by way of example and without limitation, to be various forms of interlacing. The sleeve shown in FIGS. 1-3 is constructed by braiding selected yarns together, wherein the yarns can be selected from suitable materials or combinations of materials, depending on the application. Accordingly, the sleeve 12 can be constructed from monofilament and/or multifilament yarns, with the yarns being selected depending on the performance characteristics desired. For example, the yarns can be heat settable, high temperature resistant, fire retardant, noise dampening, chemical resistant, electrically conductive or otherwise.

As best shown in FIG. 2, the support member 14 has a wall 21 with edges 23, 25 that extend between opposite ends 22, 24. Upon constructing the sleeve 12, the support member 14 is inserted into, and preferably through the cavity 18 such that the edges 23, 25 extend substantially parallel to the central axis 19 of the sleeve 12 and the opposite ends 22, 24 are exposed from opposite ends of the sleeve 12. The wall 21 has an arcuate shape in lateral cross-section, and thus, the support member 14 has an outer surface 26 that is convex and an inner surface 28 that is concave. The wall 21 of the support member 14 is constructed to span less that the entire circumferential inner perimeter of the wall 16 of the sleeve 12, and more preferably spans between about 10-135 degrees of the inner perimeter of the wall 16, for example. Upon being received in the sleeve 12, the convex outer surface 26 conforms with the wall 16 as it is brought into substantially flush abutment over substantially its entire surface with the sleeve 12 such that no substantial space is provided therebetween. As such, the concave inner surface 28 remains spaced radially outwardly from the central axis 19 of the sleeve 12 to provide the cavity 18, at least in part, and thereby, the support member 14 avoids obstruction of the passage of the wires or wire harness 20 through the cavity 18. The support member 14 can be constructed from any suitable resilient material, such as, by way of example and without limitation, metallic and/or polymeric materials and composites thereof, including reinforced polymeric materials and heat-settable materials. The example shown here was constructed of a glass/Kevlar® reinforced plastic.

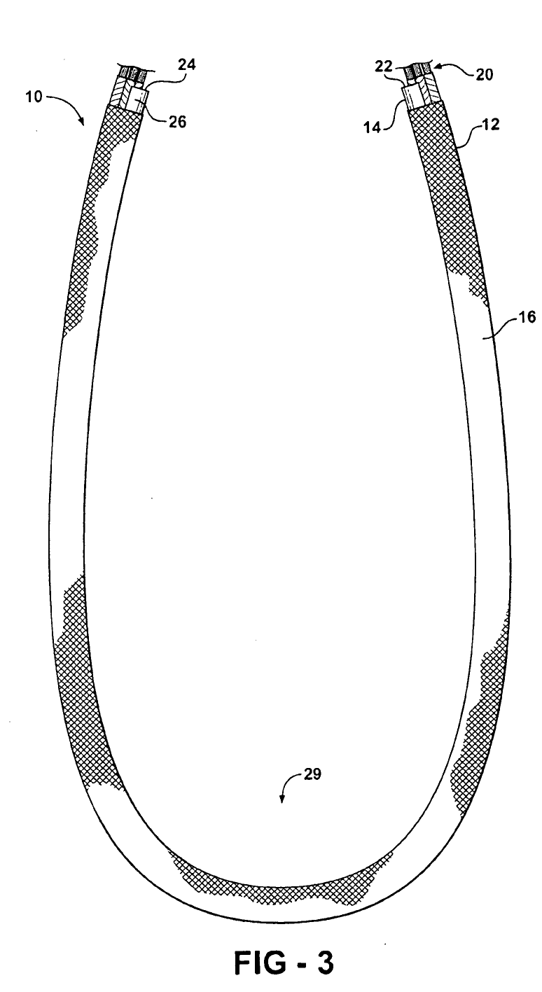

As shown in FIG. 3, in use, the protective sleeve 10 can be arranged in a generally U-shaped configuration. One of the ends of the sleeve 12 and/or support member 14 could be attached to one member, such as a fixed member, and the other end of the sleeve 12 and/or support member 14 could be attached to another member, such as a movable member, such as an electrically actuated sliding door (not shown), for example, with an arcuate generally U-shaped central section 29 being formed therebetween. As the sliding door translates, the associated end of the protective sleeve assembly 10 moves conjointly with the door, and thus, the protective sleeve assembly 10 is altered in shape, wherein the generally central arced section generally maintains its radius of arc as it translates due to the resilient support member 14. The support member 14, being resilient, maintains the sleeve 12, and thus, the elongate members 20 within the sleeve 12, in a neat arrangement as they move, while also remaining in close communication with the inner surface of the sleeve wall 16 to avoid obstructing or otherwise impinging on the wires 20. In addition, the resiliency and widthwise curvature of the support member 14 allows the sleeve 12 and elongate support member 14 to follow a predetermined, generally consistent and repeatable path while being moved back and forth. As such, the protective sleeve assembly 10 can be best oriented such that it is kept from being damaged in use.

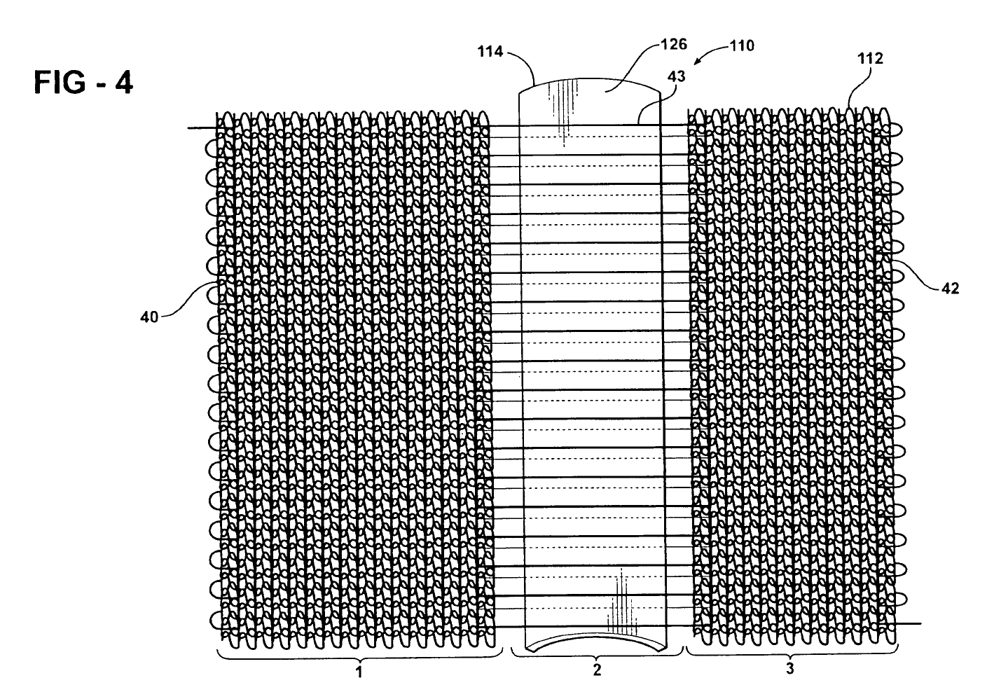

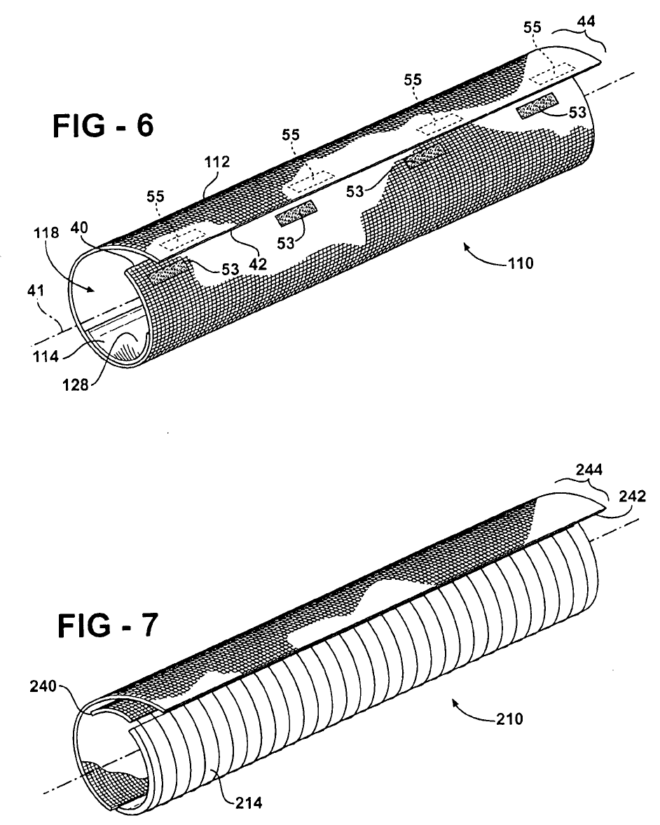

In FIGS. 4 and 6, a protective sleeve assembly 110 is shown that is constructed in accordance with another embodiment of the invention, wherein reference numerals offset by 100 are used to identify similar features as described above in the first embodiment. The protective sleeve assembly has a sleeve 112 and a support member 114. The sleeve 112 is constructed in this embodiment as an open sleeve, wherein the sleeve 112 has opposite selvages, referred to hereafter as free edges 40, 42, which extend parallel to a longitudinal axis 41 (the so-called “cigarette” wrap). The free edges 40, 42 provide an unbound seam that can be opened by applying a force sufficient to overcome the biasing force of the sleeve 112 such that the free edges can be unwrapped in spaced relation to one another to an open position. When the free edges 40, 42 are in their unwrapped position, the elongated items can either be disposed into a cavity 118, or removed therefrom. Upon inserting or removing the elongated items, the force separating the free edges 40, 42 from one another can be released so that the free edges return to their self-curled biased position to enclose the cavity 118.

As in the first embodiment, the sleeve 112 can be braided, woven, crocheted, or knitted, as shown here, constructed using a weft-insertion warp knitting process, using any suitable monofilament and/or multifilament yarns in either the weft or warp directions. The support member 114 is constructed the same as described above, and performs the same functions, and thus, is not discussed in separate detail hereafter.

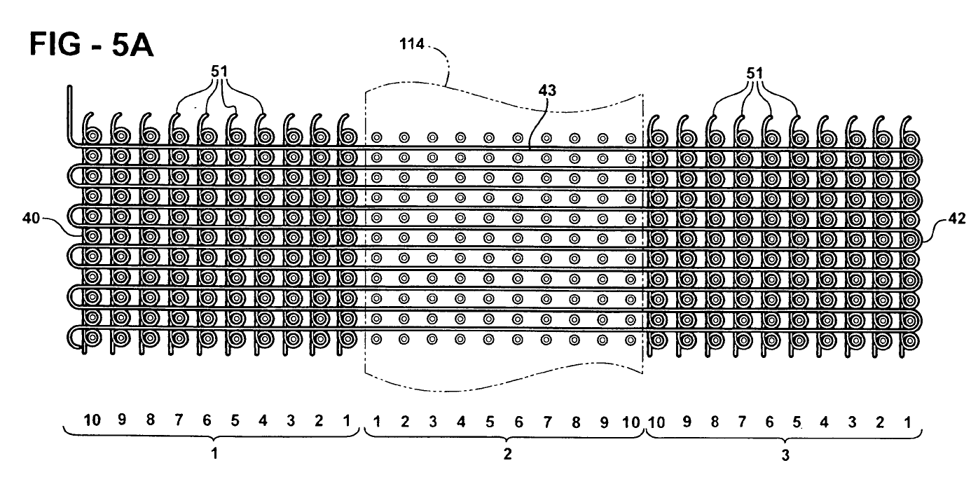

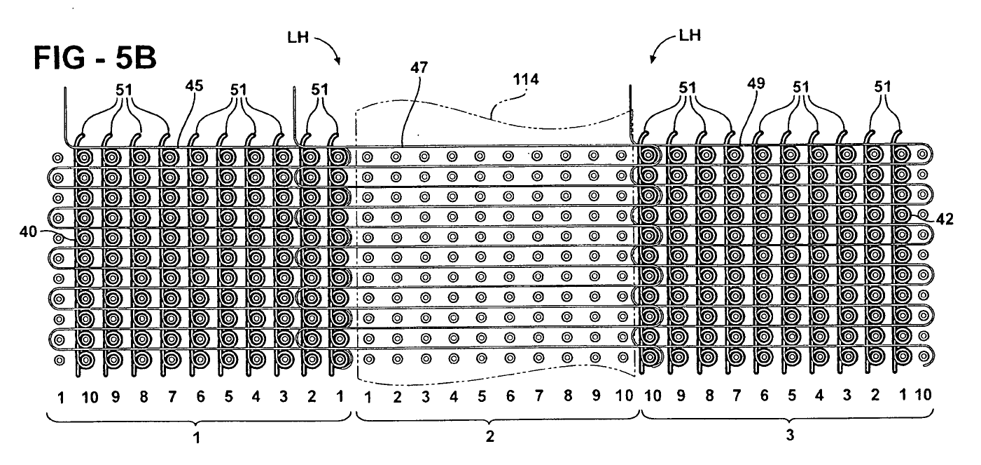

The weft-insertion warp knitted sleeve 112 is constructed such that the support member 114 is carried by the wall of the sleeve, wherein the support member 114 is shown here, for example, as being captured on its opposite sides 126, 128 by weft-inserted yarns generally mid-way between the opposite edges 40, 42. The weft-inserted yarns are shown here, by way of example and without limitations, as including one multifilament yarn 43 (FIGS. 4 and 5A) extending between the opposite edges 40, 42, and three additional sets of weft-inserted monofilament yarns 45, 47, 49 (FIG. 5B) being inserted over three separate zones 1, 2, 3, respectively, between the edges 40, 42. Zone I extends between the edge 40 and the support member 114; zone 2 extends from zone I across the support member, and zone 3 extends from zone 2 to the other edge 42. For example, as best shown in the knitting diagram of FIGS. 5A and 5B, wherein 30 needles are represented (number in 3 separate groups 1-10), the support member 114 is flanked by zones 1 and 3. Zones 1 and 3 include warp knit multifilament yarns 51 stitched with the weft-inserted yarns 43, 45, 49 using a closed chain or pillar stitch, for example. It should be recognized that other warp stitches are contemplated, such as open chain, open tricot, closed tricot, for example, and that monofilaments could be used in combination or in lieu of the multifilament yarns 51. Zone 2 includes the support member 114 and the weft-inserted yarns 43, 47, wherein the weft-inserted multifilament yarns 43 pass on one side of the support member 114, shown here as being the side facing the outside of the sleeve assembly 110, and the weft-inserted monofilament yarns 47 pass on an opposite side of the support member 114 facing the cavity 118 of the sleeve assembly 110.

The three different zones formed in part by the weft-inserted yarns 45, 47, 49 act to provide living hinges (LH, FIG. 5B) flanking the support member 114 along the length of the sleeve assembly 110, thereby allowing the sleeve assembly 110 to be wrapped more easily into its tubular form. As shown in FIG. 5B, to reduce the stress on the edge needles, the weft-inserted yarns 45, 49 are inserted across 10 needles in common with the weft-inserted multifilament 43, and then 1 needle beyond the respective edges 40, 42 corresponding to the last needles having both the weft-inserted yarn 43 and the warp knitted yarn 51. As such, small loops of the weft-inserted yarns 45, 49 extend outwardly from the edges 40, 42.

As shown in FIG. 6, the support member 114 is located and maintained generally midway between the free ends 40, 42, and thus, is generally opposite an overwrapped portion 44 of the wrapped sleeve 112. In construction, the sleeve 1 12 can be constructed as a generally flat substrate, with the support member 114 captured therein, and thereafter formed into its curled configuration. To obtain the curled configuration, the sleeve 112 can be heat-set, whereupon the free edges 40, 42 are preferably biased in overlapping relation relative to one another. Otherwise, it should be recognized that the free edges 40, 42 could have a slight gap therebetween, depending on the application requirements. As the sleeve 112 is being heat-set, the support member 114 can also take on a heat-set to attain its arcuate shape, if not preformed in advance. In addition to being heat-set, the sleeve 112 could also be configured to its curled, wrapped form via the use of fasteners adjacent the free edges 40, 42. For example, a hook-and-loop type fastener could be employed between the overlapping portions of the free edges 40, 42, wherein hook portions 53 could be attached on an outer surface of the sleeve 112 adjacent the free edge 40, and loop portions 55 could be attached on an inner surface of the sleeve 112 adjacent the free edge 42.

In addition to the sleeve 112 being heat-set or fastened to attain its curled shape, it could be constructed in a manner so that it is self-biased by at least some of the woven or knitted yarns to take on a self-curled shape. In this type of construction, weft and/or warp yarns are arranged to impart a bias force on the remaining yarns so that upon completion of the sleeve construction, the sleeve 112 curls upon exiting the weaving or knitting machine (not shown). Wherein the weft yarns 43, 45, 47, 49 impart the self-curling bias, the weft yarns are woven or knitted under tension, thereby imparting a curling tension force about the circumference of the sleeve 112. Otherwise, when the warp yarns 51 impart the self-curling bias, the warp yarns are provided as a monofilament with an increased rigidity relative to the weft yarns, thereby imparting a self-curling force on the weft yarns about the axis 41 of the sleeve 112.

In FIG. 7, a protective sleeve assembly 210 is shown that is constructed in accordance with another presently preferred embodiment, wherein reference numerals offset by 200 are used to identify similar features as described above in the first embodiment. The sleeve assembly 210 is similar to the protective sleeve assembly 110 discussed in the second embodiment, however, a support member 214 is located adjacent a free edge 240 that is wrapped immediately beneath another free edge 242. Accordingly, the support member 214 is covered at least in part by an overwrapped portion 244 of the sleeve assembly 210. Otherwise, the sleeve assembly is the same as that discussed in the second embodiment.

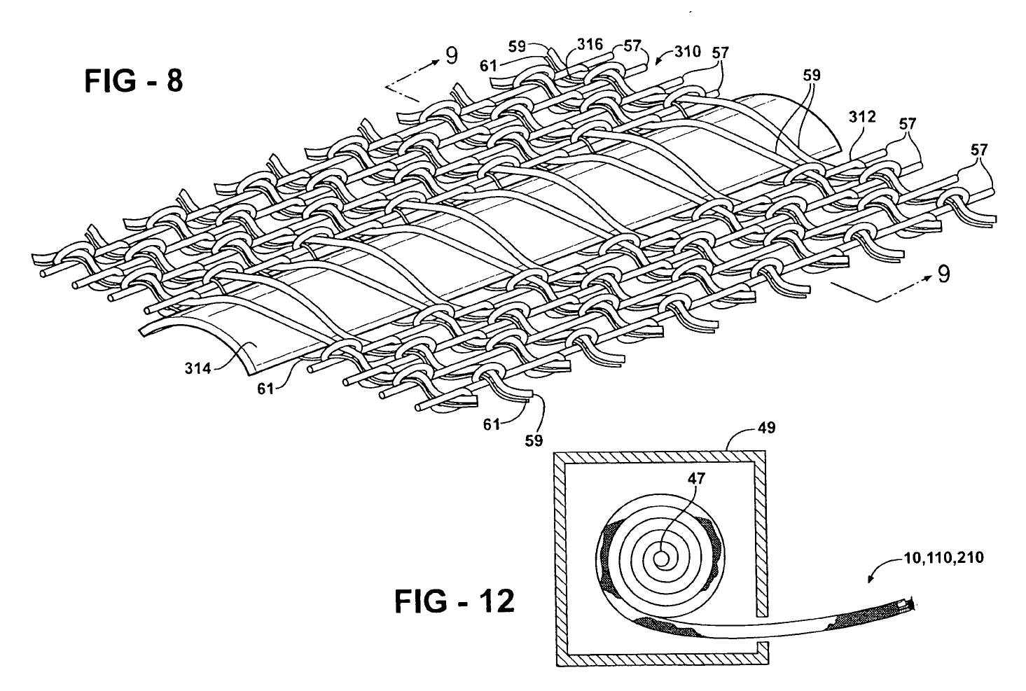

In FIG. 8, a portion of a protective sleeve assembly 310 is shown that is constructed in accordance with another embodiment of the invention, wherein reference numerals offset by 300 are used to identify similar features as described above in the first embodiment. The sleeve assembly 310 is similar to the protective sleeve assembly 110 discussed above, however, rather than being constructed in a knitting process, the sleeve assembly 310 is woven. The sleeve assembly 310 can be constructed using any suitable weaving apparatus, such as one having a single fill arm or a double fill arm, sometimes referred to as “dual pick insertion”, for example.

The sleeve assembly 310 has a wall 316 with a support member 314 captured therein so that the support member 314 is kept from being able to move circumferentially about the wall 316. The wall 316 can be constructed as a circumferentially continuous wall, such as discussed above in reference to the sleeve assembly 10, or as an open wall, wherein the sleeve assembly 310 can have opposite free edges (not shown) which extend parallel to a longitudinal axis extending along an enclosed cavity, as discussed above in reference to the sleeve assemblies 110, 210. The support member 314 can be located at any desired radial position within the wall, such as midway being the opposite edges or adjacent one of the edges provided the wall 316 is constructed in an open wall configuration. Regardless of its final form, the wall 316 is woven using monofilaments and/or multifilament yarns of any suitable material type, such as those mentioned above, for example.

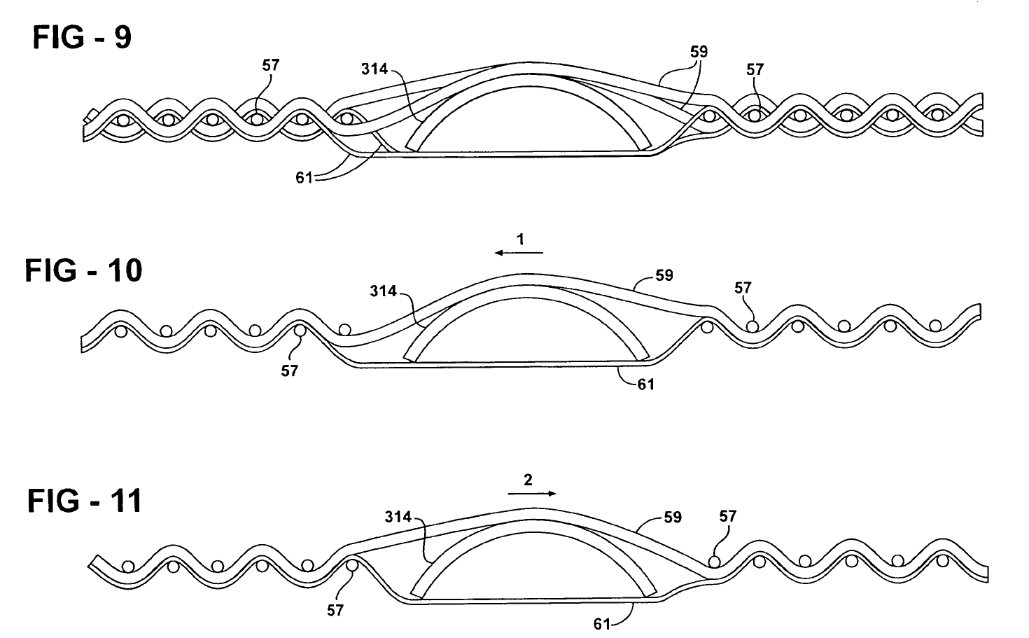

The sleeve assembly 31 0 embodiment shown has multifilament yarns 57 extending along a lengthwise warp direction and both multifilament yarn 59 and monofilament yarn 61 extending along a widthwise weft or fill direction. When using a dual pick insertion, the dual fill arm traverses the width of the sleeve 312 in one direction (shown by arrow 1 in FIG. 10) and then reverses direction to traverse the width of the sleeve 312 in an opposite direction (shown by arrow 2 in FIG. 11). The resulting sleeve 312 in this embodiment is formed having the multifilament yarn 59 woven to pass over a common side of the support member 314, shown here, by way of example, as being on the outside of the sleeve 312 (FIG. 9), and the monofilament yarn 61 woven to pass over a common side of the support member 314, shown here, by way of example, as being on the inside of the sleeve 312. Accordingly, the support member 314 is captured solely by the widthwise weft multifilament yarns 59 on one side and the widthwise weft monofilament yarns 61 on an opposite side. As mentioned, the sleeve assembly 310 could be constructed having a different construction than shown, such that the orientation of the weft yarns could be reversed to have the monofilament yarn 61 on the outside of the support member 316 and the multifilament yarn 59 on the inside of the support member 316. In addition, the sleeve could be constructed entirely of monofilament or multifilament yarns, if desired. Thus, it is to be understood that any desired permutation of yarns could be used to construct a sleeve assembly in accordance with the invention.

As shown in FIG. 12, the protective sleeve assemblies 10, 110, 210, 310 discussed above can all be stored in a coiled state and selectively uncoiled as required for use. To facilitate storage, any suitable reel 47 can be used to carry the coiled sleeve assembly. The reel 47 could be spring biased to automatically take-up the sleeve assembly 10, 110, 210 as necessary. It should be recognized that other automated mechanisms could be employed, such as a motor driven reel, to take-up and release the sleeve assembly. In addition, the reel 47 can be housed in a chamber 49 to provide protection to the coiled portion of the sleeve assembly.

Obviously, many modifications and variations of the present invention are possible in light of the above teachings. For example, the support members could be otherwise attached to the sleeves, such as by stitches, adhesives, or otherwise. It is, therefore, to be understood that within the scope of the appended claims, the invention may be practiced otherwise than as specifically described.

What is claimed is:

1. An elongate sleeve assembly for protecting elongated members, said sleeve, comprising:
a textile sleeve having a cylindrical wall with an inner surface providing at least in part a single cavity extending along a longitudinal axis of said sleeve for receiving said elongate members; and
a resilient support member arranged in communication with said cylindrical wall and extending less than completely about a circumference of said wall, said support member having an inner surface spaced radially outwardly from said longitudinal axis, said inner surface of said support member providing at least in part said single cavity.

2. The sleeve assembly of claim 1 wherein said support member has a convex outer surface abutting said inner surface of said sleeve.

3. The sleeve assembly of claim 2 wherein said inner surface of said support member is concave

4. The sleeve assembly of claim 3 wherein said wall is circumferentially continuous.

5. The sleeve assembly of claim 1 wherein said wall is circumferentially discontinuous having opposite free edges extending along said longitudinal axis.

6. The sleeve assembly of claim 5 wherein said opposite free edges overlap one another to provide an overwrapped portion, said support member being interlaced in said wall in said overwrapped portion.

7. The sleeve assembly of claim 5 wherein said opposite free edges overlap one another to provide an overwrapped portion, said support member being interlaced in said wall diametrically opposite said overwrapped portion.

8. The sleeve assembly of claim 1 wherein said support member has an outer surface facing outwardly from said longitudinal axis, said support member being captured in said wall of said sleeve by yarns extending over said outer surface of said support member and by yarns extending over said inner surface of said support member.

9. The sleeve assembly of claim 8 wherein said yarns extend along a direction perpendicular to said longitudinal axis.

10. The sleeve assembly of claim 8 wherein said wall of said sleeve is knitted.

11. The sleeve assembly of claim 10 wherein said wall of said sleeve is weft-insertion warp knitted, said yarns extending perpendicular to said longitudinal axis being weft inserted.

12. The sleeve assembly of claim 8 wherein said wall of said sleeve is woven.

13. The sleeve assembly of claim 8 wherein said wall of said sleeve has yarns biased to self-curl.

14. The sleeve assembly of claim 1 wherein said wall of said sleeve is braided.

15. An elongate textile sleeve assembly for protecting elongated members, said sleeve, comprising:
a sleeve having a tubular wall of interlaced yarns providing at least in part a cavity extending along a longitudinal axis of said sleeve for receiving said elongate members; and
a resilient support member having an inner concave surface and an outer convex surface extending less than completely about a circumference of said wall, said support member being carried by said wall by at least some of said yarns extending over said inner and outer surfaces of said support member.

16. The sleeve assembly of claim 15 wherein said support member has opposite edges extending generally parallel to said longitudinal axis, said wall having a knit portion extending laterally from at least one of said edges of said support member.

17. The sleeve assembly of claim 16 wherein said yarns extending over said inner and outer surfaces are weft-inserted within said knit portion, said weft inserted yarns extending perpendicular to said longitudinal axis.

18. The sleeve assembly of claim 17 wherein said wall has knit portions extending laterally from both of said edges.

19. The sleeve assembly of claim 15 wherein said support member has opposite edges extending generally parallel to said longitudinal axis, said wall having a woven portion extending laterally from at least one of said edges.

20. The sleeve assembly of claim 19 wherein said yarns extending over said inner and outer surfaces are weft yarns forming a portion of said woven portion.

21. A method of constructing an elongate sleeve assembly for protecting elongate members, comprising:
providing a support member having a wall with a concave inner surface and a convex outer surface opposite said inner surface;
forming a textile sleeve with a plurality of yarns, said sleeve having a wall with an inner surface defining at least in part a cavity extending along a longitudinal axis of said sleeve for receiving said elongate members; and
interlacing at least some of said yarns during the forming step over opposite sides of said support member and capturing said support member within said wall.

22. The method of claim 21 further including knitting said yarns in the forming step.

23. The method of claim 22 further including using a weft-insertion warp knitting process to knit said yarns and interlacing weft-inserted yarns on opposite sides of said support member to capture said support member in said wall.

24. The method of claim 21 further including weaving said yarns in the forming step.

25. The method of claim 24 further including using yarns extending in a weft direction to capture said support member in said wall.
